(19) United States
(12) Patent Application Publication
(10) Pub. No.: US 2009/0015554 A1
(43) Pub. Date: Jan. 15, 2009

(54) SYSTEM, CONTROL MODULE, AND METHOD FOR REMOTELY CONTROLLING A COMPUTER WITH OPTICAL TRACKING OF AN OPTICAL POINTER

(75) Inventors: Chia-Chun Tsou, Taipei Hsien (TW); Chih-Heng Fang, Taipei Hsien (TW)

Correspondence Address: DARBY & DARBY P.C., P.O. BOX 770, Church Street Station, New York, NY, 10008-0770, US

(73) Assignee: UTECHZONE CO., LTD., Taipei Hsien (TW)

(21) Appl. No.: 12/045,310

(22) Filed: Mar. 10, 2008

(30) Foreign Application Priority Data
Jul. 12, 2007 (TW) 096125394

(51) Int. Cl. G09G 5/08

(52) U.S. Cl. 345/158

(57) ABSTRACT

A control module is used with a projector projecting an image frame having at least one icon from a computer onto a screen, and an optical pointer projecting an optical cursor onto the screen, and obtains a close-loop optical track of the optical cursor based on positions of the optical cursor in a series of images of the projected image frame and the optical cursor captured by an image capturing device, selects an image portion of one captured image based on the close-loop optical track of the optical cursor to serve as a standard sample image, compares the standard sample image with the image frame to determine an image block from the image frame most similar to the standard sample image, and generates a control signal based on the image block to control the computer to execute a command associated with at most one icon contained in the image block.

### CROSS-REFERENCE TO RELATED APPLICATION

This application claims priority of Taiwanese Application No. 096125394, filed on Jul. 12, 2007.

### BACKGROUND OF THE INVENTION

1. Field of the Invention

The invention relates to remote control of a computer, more particularly to a system, control module, and method for remotely controlling a computer with optical tracking of an optical pointer.

2. Description of the Related Art

A conventional method for remotely controlling a computer is disclosed in U.S. Pat. No. 6,275,214. In the conventional method, a projector is used to project an image frame outputted by the computer onto an external screen. A laser pointer is used to generate an optical cursor and to project the optical cursor onto the external screen. A camera is used to capture an image of the projected image frame and the optical cursor. The captured image is processed to detect at least one property of the optical cursor to generate a corresponding command to control the computer.

However, prior to detection of the property of the optical cursor, it is necessary to perform coordinate transformation, i.e., determine locations of corners of an area in the captured image corresponding to the projected image frame. In addition, coordinate calibration is required whenever the projector or the camera is moved during use, thereby resulting in inconvenience during use.

### SUMMARY OF THE INVENTION

Therefore, the object of the present invention is to provide a system, control module, and method for remotely controlling a computer with optical tracking of an optical pointer that can overcome the aforesaid drawbacks of the prior art.

According to one aspect of the present invention, there is provided a method for remotely controlling a computer. The computer outputs an image frame that contains at least one icon and that is projected onto a remotely located screen. The method comprises the steps of:

a) projecting an optical cursor generated by a hand-held optical pointer onto the screen;

b) capturing a series of images of the projected image frame and the optical cursor;

c) detecting a position of the optical cursor in each of the captured images;

d) obtaining a close-loop optical track of the optical cursor based on the detected positions of the optical cursor;

e) selecting an image portion of one of the captured images based on the close-loop optical track of the optical cursor to serve as a standard sample image;

f) comparing the standard sample image with the image frame so as to determine an image block from the image frame most similar to the standard sample image and containing at most one icon; and

g) generating a control signal based on the image block to control the computer to execute a command associated with the icon contained in the image block.

According to another aspect of the present invention, there is provided a system for remotely controlling a computer. The computer outputs an image frame that contains at least one icon. The system comprises:

a projector adapted to be connected electrically to the computer for projecting the image frame from the computer onto a remotely located screen;

a hand-held optical pointer for projecting an optical cursor generated thereby onto the screen;

an image capturing device for capturing a series of images of the projected image frame and the optical cursor; and

a control module adapted to be connected electrically to the computer for receiving and storing the image frame therefrom, and connected electrically to the image capturing device for receiving and storing the images captured by the image capturing device.

The control module detects a position of the optical cursor in each of the captured images, obtains a close-loop optical track of the optical cursor based on the detected positions of the optical cursor, selects an image portion of one of the captured images based on the close-loop optical track of the optical cursor to serve as a standard sample image, compares the standard sample image with the image frame so as to determine an image block from the image frame most similar to the standard sample image and containing at most one icon, and outputs a control signal based on the image block to the computer such that the computer executes a command associated with the icon contained in the image block in response to the control signal from the control module.

According to a further aspect of the present invention, there is provided a control module adapted for use with a computer outputting an image frame that contains at least one icon,

a projector connected electrically to the computer for projecting the image frame onto a remotely located screen,

a hand-held optical pointer for projecting an optical cursor generated thereby onto the screen, and

an image capturing device for capturing a series of images of the projected image frame and the optical cursor.

The control module is adapted to be connected electrically to the computer and the image capturing device, and comprises:

a memory unit for storing the image frame from the computer and the images captured by the image capturing device;

a sample-selecting unit coupled to the memory unit, detecting a position of the optical cursor in each of the captured images, obtaining a close-loop optical track of the optical cursor based on the positions of the optical cursor detected thereby, and selecting an image portion of one of the captured images stored in the memory unit based on the close-loop optical track of the optical cursor to serve as a standard sample image;

a comparing unit coupled to the memory unit and the sample-selecting unit for comparing the standard sample image selected by the sample-selecting unit with the image frame stored in the memory unit so as to determine an image block from the image frame most similar to the standard sample image and containing at most one icon; and

a control signal generating unit coupled to the comparing unit, adapted to be coupled to the computer, and outputting a control signal to the computer based on the image block determined by the comparing unit such that the computer executes a command associated with the icon contained in the image block in response to the control signal from the control signal generating unit.

According to still another aspect of the present invention, there is provided a method for generating a control signal to remotely control a computer. The computer outputs an image frame that contains at least one icon, and is used in conjunction with a projector connected electrically to the computer for projecting the image frame from the computer onto a remotely located screen,

a hand-held optical pointer for projecting an optical cursor generated thereby onto the screen, and

an image capturing device for capturing a series of images of the projected image frame and the optical cursor.

The method comprises the steps of:

i) detecting a position of the optical cursor in each of the captured images;

ii) obtaining a close-loop optical track of the optical cursor based on the detected positions of the optical cursor;

iii) selecting an image portion of one of the captured images based on the close-loop optical track of the optical cursor to serve as a standard sample image;

iv) comparing the standard sample image with the image frame so as to determine an image block from the image frame most similar to the standard sample image and containing at most one icon; and

v) generating the control signal based on the image block to control the computer to execute a command associated with the icon contained in the image block.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic block diagram illustrating a system that is configured for implementing the preferred embodiment of a method for remotely controlling a computer according to the present invention;

FIG. 2 is a flow chart illustrating how the computer is remotely controlled according to the method of the preferred embodiment;

FIG. 3a is a schematic view illustrating an exemplary image frame outputted by the computer in the preferred embodiment;

FIG. 3b is a schematic view illustrating an exemplary standard sample image associated with the exemplary image frame of FIG. 3a and obtained in the preferred embodiment;

FIG. 4a is a schematic view illustrating another image frame outputted by the computer in the preferred embodiment; and

FIG. 4b is a schematic view illustrating another exemplary standard sample image associated with the exemplary image frame of FIG. 4a and obtained in the preferred embodiment.

### DETAILED DESCRIPTION OF THE PREFERRED EMBODIMENT

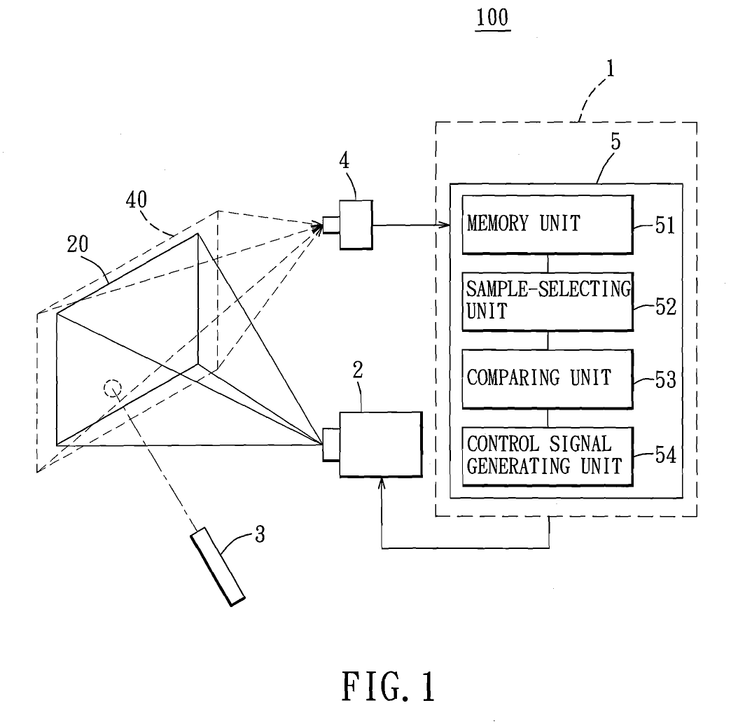

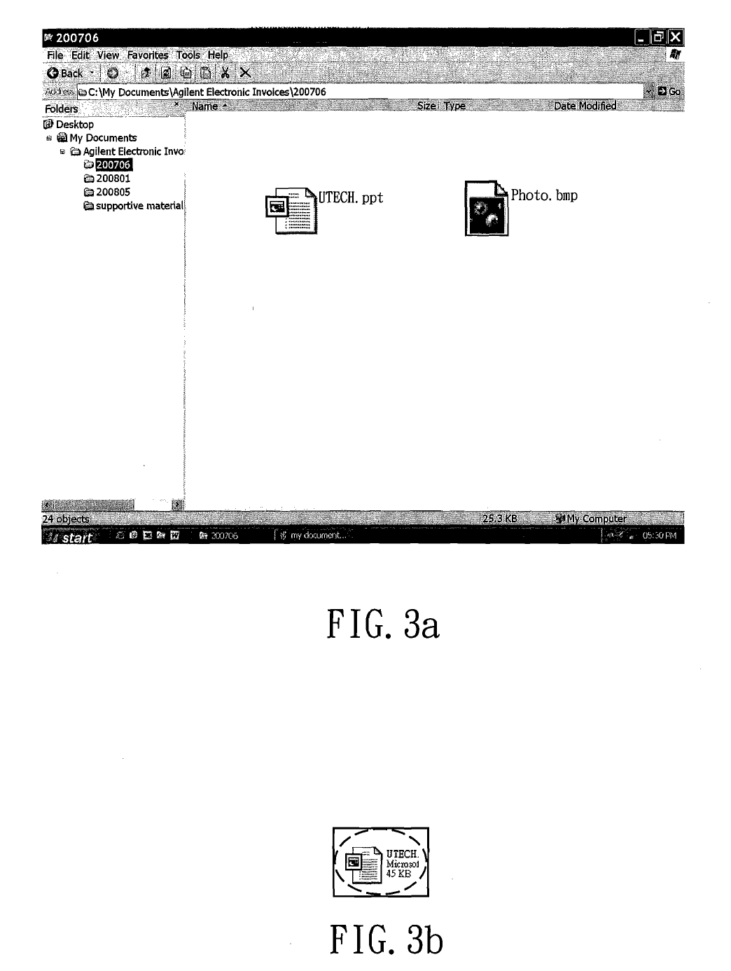

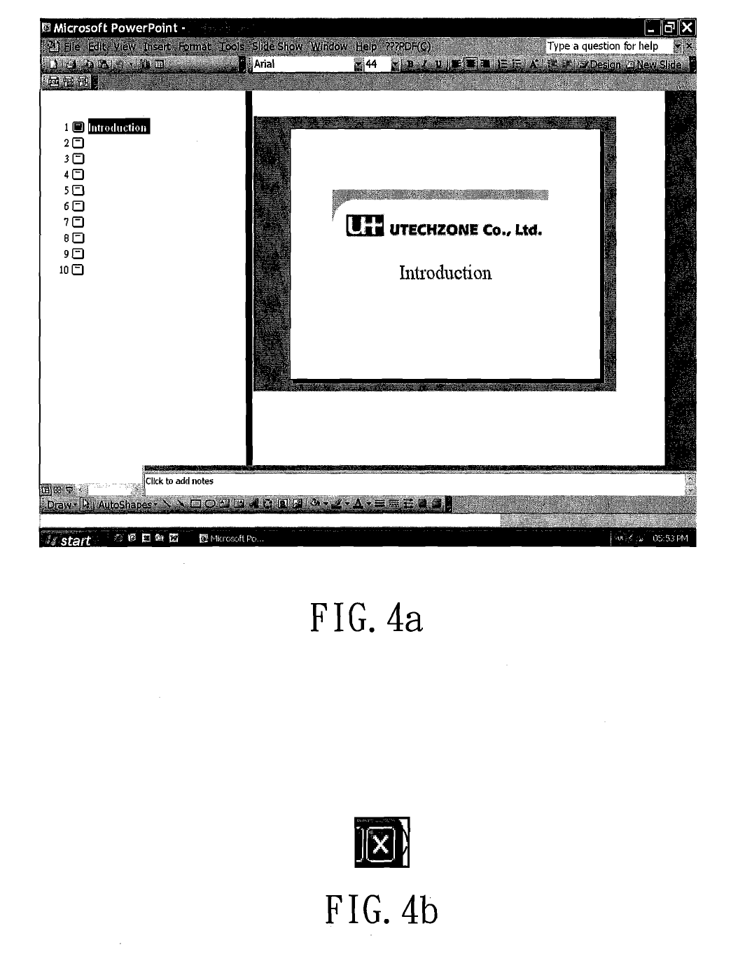

FIG. 1 illustrates a system 100 that is configured for implementing the preferred embodiment of a method for remotely controlling a computer 1 according to the present invention. The computer 1 outputs an image frame that contains at least one icon, as shown in FIGS. 3a and 4a. The system 100 includes a projector 2, a hand-held optical pointer 3, an image capturing device 4, and a control module 5.

The projector 2 is adapted to be connected electrically to the computer 1 for projecting the image frame from the computer 1 onto a remotely located screen (not shown).

The optical pointer 3, such as a laser pointer or an LED pointer, is operable to generate an optical cursor and to project the optical cursor generated thereby onto the screen.

The image capturing device 4, such as a charge-coupled device, is configured to capture a series of images 40 of the projected image frame 20 and the optical cursor in a predetermined frame capture rate. In this embodiment, the predetermined frame capture rate is 30 frames per second (FPS). In addition, the captured images 40 preferably contain the whole projected image frame 20

In this embodiment, the control module 5 is built-into the computer 1, is adapted to be connected electrically to the computer 1 for receiving and storing the image frame therefrom, and is connected electrically to the image capturing device 4 for receiving and storing the images 40 captured by the image capturing device 4. The control module 5 includes a memory unit 51 for storing the image from the computer 1 and the images 40 captured by the image capturing device 4, a sample-selecting unit 52 coupled to the memory unit 51, a comparing unit 53 coupled to the sample-selecting unit 52, and a control signal generating unit 54 coupled to the comparing unit 53 and adapted to be coupled to the computer 1.

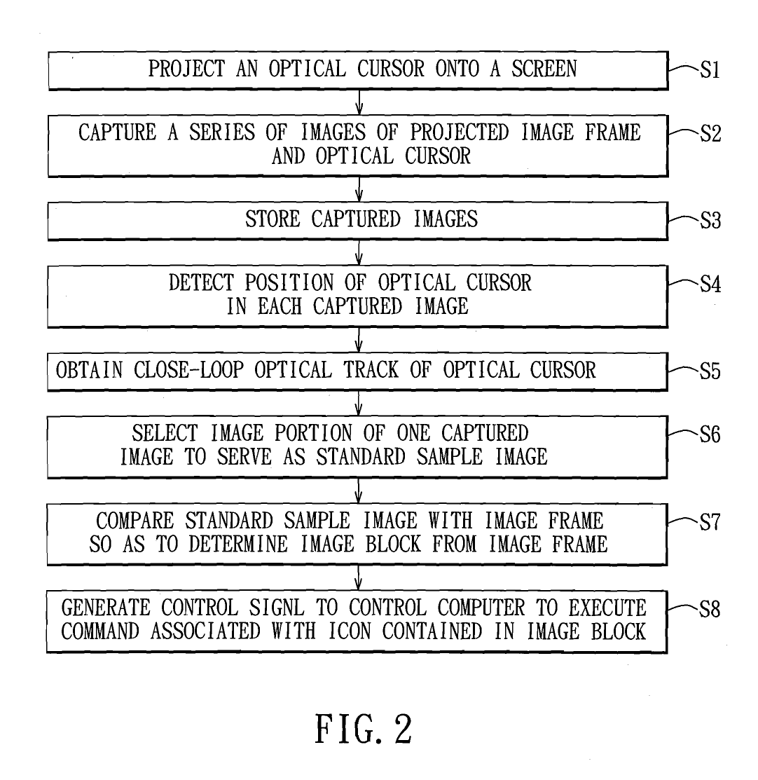

Referring to FIG. 2, there is shown a flow chart to illustrate how the computer 1 is remotely controlled in accordance with the method of the preferred embodiment.

In step S1, the optical pointer 3 is operated to generate an optical cursor that is projected onto the screen for a time period.

In step S2, the image capturing device 4 is configured to capture a series of images 40 of the projected image frame 20 and the optical cursor during a predetermined time period, such as 2 seconds. Since the predetermined frame capture rate is 30 FPS, a number of the captured images 40 captured within 2 seconds is 60.

In step S3, the images 40 captured in step S2 are stored in the memory unit 51 of the control module 5.

In step S4, the sample-selecting unit 52 detects a position of the optical cursor in each of the captured images 40. In this embodiment, the position of the optical cursor in each of the captured images 40 is detected based on at least one of intensity, shape and color of the optical cursor. For example, if the intensity of the captured image 40 is within a range of from 0 lumen to 255 lumens, the position of the optical cursor can be detected by presuming the intensity of the optical cursor to be greater than a threshold intensity, such as 125 lumens.

In step S5, the sample-selecting unit 52 obtains a close-loop optical track of the optical cursor based on the positions of the optical cursor detected thereby. It is noted that, for example, the close-loop optical track of the optical cursor can be obtained using only the positions of the optical cursor in a first one to a fifty-first one of the sixty captured images 40, i.e., the position of the optical cursor in the first one of the sixty captured images 40 corresponds to that in the fiftieth one of the sixty captured images 40.

In step S6, the sample-selecting unit 52 selects an image portion of one of the captured images 40 stored in the memory unit 51 based on the close-loop optical track of the optical cursor to serve as a standard sample image. In this embodiment, as shown in FIGS. 3b and 4b, the selected image portion, i.e., the standard sample image, is a smallest rectangular area that encompasses an area of said one of the captured images 40 enclosed by the close-loop optical track of the optical cursor. For example, the standard sample image shown in FIG. 3b contains an icon representing a Microsoft PowerPoint document, and the standard sample image shown in FIG. 4b contains an icon representing closing of a document. In addition, in the example described above, said one of the captured images 40 is the fifty-first one of the sixty captured images 40.

In step S7, the comparing unit 53 compares the standard sample image selected by the sample-selecting unit 52 with the image frame stored in the memory unit 51 so as to determine an image block from the image frame most similar to the standard sample image and containing at most one icon. In this embodiment, the image block is determined through calculation of correlation coefficients between the standard sample image and portions of the image frame. More specifically, the image block is determined by comparing at least one of shape, color and gray level of the portions of the image frame with that of the standard sample image.

In step S8, the control signal generating unit 54 outputs a control signal to the computer 1 based on the image block determined by the comparing unit 53 such that the computer 1 executes a command associated with the icon contained in the image block in response to the control signal from the control signal generating unit 54. In this embodiment, the control signal is associated with control of the computer 1 by a pointing device, such as a mouse. For instance, when the icon contained in the image block is that of a Microsoft PowerPoint document (see FIG. 3b), control for the computer 1 based on the control signal from the control signal generating unit 54 is equivalent to execution of the command corresponding to opening the Microsoft PowerPoint document indicated by the icon using a mouse connected electrically to the computer 1. Alternatively, when the icon contained in the image block represents closing of a document associated with that in FIG. 4a (see FIG. 4b), control for the computer 1 based on the control signal from the control signal generating unit 54 is equivalent to execution of the command corresponding to closing the Microsoft PowerPoint document shown in FIG. 4b using a mouse connected electrically to the computer 1.

In sum, in the system 100, the standard sample image is obtained based on the captured images 40, and is then compared with the image frame without requiring coordinate transformation between the captured images 40 and the image frame. In particular, the close-loop optical track of the optical cursor can be obtained without the need for coordinate calibration required in the aforesaid prior art even though the projector 2 or the image capturing device 4 is moved during use, thereby resulting in convenience during use. As a result, remote control of the computer 1 through the optical pointer 3 can be accurately achieved in accordance with the method of the present invention.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. A method for remotely controlling a computer, the computer outputting an image frame that contains at least one icon and that is projected onto a remotely located screen, said method comprising the steps of:
a) projecting an optical cursor generated by a hand-held optical pointer onto the screen;
b) capturing a series of images of the projected image frame and the optical cursor;
c) detecting a position of the optical cursor in each of the captured images;
d) obtaining a close-loop optical track of the optical cursor based on the detected positions of the optical cursor;
e) selecting an image portion of one of the captured images based on the close-loop optical track of the optical cursor to serve as a standard sample image;
f) comparing the standard sample image with the image frame so as to determine an image block from the image frame most similar to the standard sample image and containing at most one icon; and
g) generating a control signal based on the image block to control the computer to execute a command associated with the icon contained in the image block.

2. The method as claimed in claim 1, wherein, in step e), the image block is determined through calculation of correlation coefficients between the standard sample image and portions of the image frame.

3. The method as claimed in claim 1, wherein, in step e), the image block is determined by comparing at least one of shape, color and gray level of portions of the image frame with that of the standard sample image.

4. The method as claimed in claim 1, wherein, in step g), the control signal is associated with control of the computer by a pointing device.

5. The method as claimed in claim 1, wherein, in step c), the position of the optical cursor in each of the captured images is detected based on at least one of intensity, shape and color of the optical cursor.

6. The method as claim in claim 1, wherein, in step e) the selected image portion is a smallest rectangular area that encompasses an area of said one of the captured images enclosed by the close-loop optical track of the optical cursor.

7. A system for remotely controlling a computer, the computer outputting an image frame that contains at least one icon, said system comprising:
a projector adapted to be connected electrically to the computer for projecting the image frame from the computer onto a remotely located screen;
a hand-held optical pointer for projecting an optical cursor generated thereby onto the screen;
an image capturing device for capturing a series of images of the projected image frame and the optical cursor; and
a control module adapted to be connected electrically to the computer for receiving and storing the image frame therefrom, and connected electrically to said image capturing device for receiving and storing the images captured by said image capturing device;
wherein said control module detects a position of the optical cursor in each of the captured images, obtains a close-loop optical track of the optical cursor based on the detected positions of the optical cursor, selects an image portion of one of the captured images based on the close-loop optical track of the optical cursor to serve as a standard sample image, compares the standard sample image with the image frame so as to determine an image block from the image frame most similar to the standard sample image and containing at most one icon, and outputs a control signal based on the image block to the computer such that the computer executes a command associated with the icon contained in the image block in response to the control signal from said control module.

8. The system as claimed in claim 7, wherein said control module includes:
a memory unit for storing the image frame from the computer and the images captured by said image capturing device;
a sample-selecting unit coupled to said memory unit, detecting the position of the optical cursor in each of the captured images, obtaining the close-loop optical track of the optical cursor based on the positions of the optical cursor detected thereby, and selecting the image portion of said one of the captured images stored in said memory unit based on the close-loop optical track of the optical cursor to serve as the standard sample image;
a comparing unit coupled to said memory unit and said sample-selecting unit for comparing the standard sample image selected by said sample-selecting unit with the image frame stored in said memory unit so as to determine the image block from the image frame most similar to the standard sample image and containing at most one icon; and
a control signal generating unit coupled to said comparing unit, adapted to be coupled to the computer, and outputting the control signal to the computer based on the image block determined by said comparing unit such that the computer executes the command associated with the icon contained in the image block in response to the control signal from said control signal generating unit.

9. The system as claimed in claim 8, wherein the image block is determined by said comparing unit through calculation of correlation coefficients between the standard sample image and portions of the image frame.

10. The system as claimed in claim 8, wherein said comparing unit determines the image block by comparing at least one of shape, color and gray level of portions of the image frame with that of the standard sample image.

11. The system as claimed in claim 8, wherein the control signal outputted by said control signal generating unit is associated with control of the computer by a pointing device.

12. The system as claimed in claim 8, wherein the position of the optical cursor in each of the captured images is detected by said sample-selecting unit based on at least one of intensity, shape and color of the optical cursor.

13. The system as claim in claim 8, wherein the image portion selected by said sample-selecting unit is a smallest rectangular area that encompasses an area of said one of the captured images enclosed by the close-loop optical track of the optical cursor.

14. A control module adapted for use with
a computer outputting an image frame that contains at least one icon,
a projector connected electrically to the computer for projecting the image frame onto a remotely located screen,
a hand-held optical pointer for projecting an optical cursor generated thereby onto the screen, and
an image capturing device for capturing a series of images of the projected image frame and the optical cursor,
said control module being adapted to be connected electrically to the computer and the image capturing device, and comprising:
a memory unit for storing the image frame from the computer and the images captured by the image capturing device;
a sample-selecting unit coupled to said memory unit, detecting a position of the optical cursor in each of the captured images, obtaining a close-loop optical track of the optical cursor based on the positions of the optical cursor detected thereby, and selecting an image portion of one of the captured images stored in said memory unit based on the close-loop optical track of the optical cursor to serve as a standard sample image;
a comparing unit coupled to said memory unit and said sample-selecting unit for comparing the standard sample image selected by said sample-selecting unit with the image frame stored in said memory unit so as to determine an image block from the image frame most similar to the standard sample image and containing at most one icon; and
a control signal generating unit coupled to said comparing unit, adapted to be connected electrically to the computer, and outputting a control signal to the computer based on the image block determined by said comparing unit such that the computer executes a command associated with the icon contained in the image block in response to the control signal from said control signal generating unit.

15. The control module as claimed in claim 14, wherein the image block is determined by said comparing unit through calculation of correlation coefficients between the standard sample image and portions of the image frame.

16. The control module as claimed in claim 14, wherein said comparing unit determines the image block by comparing at least one of shape, color and gray level of portions of the image frame with that of the standard sample image.

17. The control module as claimed in claim 14, wherein the control signal outputted by said control signal generating unit is associated with control of the computer by a pointing device.

18. The control module as claimed in claim 14, wherein the position of the optical cursor in each of the captured images is detected by said sample-selecting unit based on at least one of intensity, shape and color of the optical cursor.

19. The control module as claim in claim 14, wherein the image portion selected by said sample-selecting unit is a smallest rectangular area that encompasses an area of said one of the captured images enclosed by the close-loop optical track of the optical cursor.

20. A method for generating a control signal to remotely control a computer, the computer outputting an image frame that contains at least one icon and being used in conjunction with
a projector for projecting the image frame from the computer onto a remotely located screen,
a hand-held optical pointer for projecting an optical cursor generated thereby onto the screen, and
an image capturing device for capturing a series of images of the projected image frame and the optical cursor,
said method comprising the steps of:
i) detecting a position of the optical cursor in each of the captured images;
ii) obtaining a close-loop optical track of the optical cursor based on the detected positions of the optical cursor;
iii) selecting an image portion of one of the captured images based on the close-loop optical track of the optical cursor to serve as a standard sample image;
iv) comparing the standard sample image with the image frame so as to determine an image block from the image frame most similar to the standard sample image and containing at most one icon; and
v) generating the control signal based on the image block to control the computer to execute a command associated with the icon contained in the image block.

21. The method as claimed in claim 20, wherein, in step iii), the image block is determined through calculation of correlation coefficients between the standard sample image and portions of the image frame.

22. The method as claimed in claim 20, wherein, in step iii), the image block is determined by comparing at least one of shape, color and gray level of portions of the image frame with that of the standard sample image.

23. The method as claimed in claim 20, wherein, in step v), the control signal is associated with control of the computer by a pointing device.

24. The method as claimed in claim 20, wherein, in step i), the position of the optical cursor in each of the captured images is detected based on at least one of intensity, shape and color of the optical cursor.

25. The method as claim in claim 20, wherein, in step b), the selected image portion is a smallest rectangular area that encompasses an area of said one of the captured images enclosed by the close-loop optical track of the optical cursor.
